(19) United States
(12) Patent Application Publication
(10) Pub. No.: US 2017/0155605 A1
(43) Pub. Date: Jun. 1, 2017

(54) VIDEO COMMUNICATION SYSTEM AND METHOD FOR USING SAME

(71) Applicant: NSIXTY, LLC, Cincinnati, OH (US)

(72) Inventors: James Matthew Stephens, Cincinnati, OH (US); Matthew Berlage, Cincinnati, OH (US)

(21) Appl. No.: 15/429,696

(22) Filed: Feb. 10, 2017

Related U.S. Application Data
(63) Continuation-in-part of application No. 15/054,307, filed on Feb. 26, 2016.
Application No. 15/054,307 is a continuation of application No. 14/084,258, filed on Nov. 19, 2013, now Pat. No. 9,313,456.
Application No. 14/084,258 is a continuation of application No. 12/688,238, filed on Jan. 15, 2010, now Pat. No. 8,619,115.
(60) Provisional application No. 61/205,140, filed on Jan. 15, 2009.

(51) Int. Cl. H04L 12/58; G06Q 30/02; H04N 5/77

(52) U.S. Cl. CPC H04L 51/10; H04L 51/38; H04N 5/77; G06Q 30/0239

(57) ABSTRACT

The present invention provides a media communication system including a kiosk for recording a media messages created by a user. The kiosk includes a user interface for receiving user information such as name, address, email, and other identifying information. The kiosk further includes a message-recording device for recording a user media message. The kiosk may issue a reward to a user. The kiosk selects the reward based on the time, date, location, or an event. Users may collect rewards from the kiosk.

### CROSS-REFERENCE TO RELATED APPLICATION

This application is a Continuation-in-Part of U.S. application Ser. No. 15/054,307 which is a Continuation of U.S. application Ser. No. 14/084,258 entitled “Video Communication System and Method For Using Same,” filed on Nov. 19, 2013 now U.S. Pat. No. 9,313,456 issued on Apr. 12, 2016, which is a Continuation of U.S. application Ser. No. 12/688,238 entitled “Video Communication System and Method For Using Same,” filed on Jan. 15, 2010, now U.S. Pat. No. 8,619,115 issued on Dec. 31, 2013, which claims the benefit of U.S. Provisional Application 61/205,140 entitled “Video Communication System and Method For Using Same,” filed Jan. 15, 2009, each of which is incorporated by reference in its entirety.

### BACKGROUND

The present invention relates generally to a system and method for recording, transmitting, and accessing video communications.

Patrons at entertainment venues, sporting events, tourist attractions, and other leisure and business events often enjoy capturing visual memories of the event to share with friends and family. One way to share memories and messages from an event is by purchasing a post card, photograph or picture. Postcards, however, are limited to the pictures that are available for purchase and do not always convey the desired message. Furthermore, postcards are tedious because a user must prepare and mail them to each and every individual recipient.

In recent years, various electronic devices have been developed to improve the ways in which visual memories can be captured and shared. Devices such as digital cameras and video cameras allow users to capture and store high quality photos and video. However, these devices are often limited in their capacity to share and transfer the recorded pictures and video. Specifically, the picture and video files must be removed from the device and transferred to a computer or other medium before being shared with others. Additionally, the user is required to carry the digital camera or video camera with them at the given event.

More recently, other devices and technologies have been developed to improve the sharing of video files. Many cell phones, PDAs, and other electronic devices provide a convenient and direct way of communicating a photo or video message to an individual. For example, many cell phones are equipped with digital cameras for recording photos or videos. Additionally, many phones allow an electronic photo or video file to be sent to another cell phone via a text or an email or uploaded directly to the Internet. However, picture and sound quality on most mobile devices is limited due to the size of the electronic media files, and general cost constraints. Furthermore, sharing and accessibility of the video or photo is limited in many cases to other cell phones and mobile devices.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

A video communication system is provided. The video communication system includes a kiosk for recording video messages created by a user and a database for storing and providing access to the video messages. The kiosk includes a user interface for receiving user information such as name, address, email, and other identifying information. The kiosk further includes a message-recording device for recording a user video message. The video message and user information are uploaded to a database. The database associates the video message with the user information. The video message may be accessed via a website by inputting user information.

A media communication system may include a kiosk comprising a user interface for interacting with a user. The kiosk may be located at a physical location. The kiosk may generate location based rewards. The rewards may be physical rewards or digital rewards. Digital rewards may be transmitted to a user device or user account. The rewards may be exclusive to a particular location, set of locations, event, or time period. The media communcitions system may include a database that stores a history of user interactions with the kiosk. The history may identify awarded rewards, redeemed rewards, or the like.

The following description and the drawings disclose various illustrative aspects. Some improvements and novel aspects may be expressly identified, while others may be apparent from the description and drawings.

### DESCRIPTION OF THE DRAWINGS

Objects and advantages together with the operation of the invention may be better understood by reference to the following detailed description taken in connection with the following illustrations, wherein:

FIG. 1 illustrates a system diagram of a global video communication system.

FIG. 2 illustrates a kiosk for recording a video communication.

FIG. 3 illustrates an alternative embodiment of a kiosk for recording a video communication.

FIG. 4 illustrates a flow chart of a method for capturing, storing and retrieving a video communication.

FIG. 5 illustrates a user device for a media communication.

FIG. 6 illustrates a kiosk for recording media messages and receiving rewards in a media communication system.

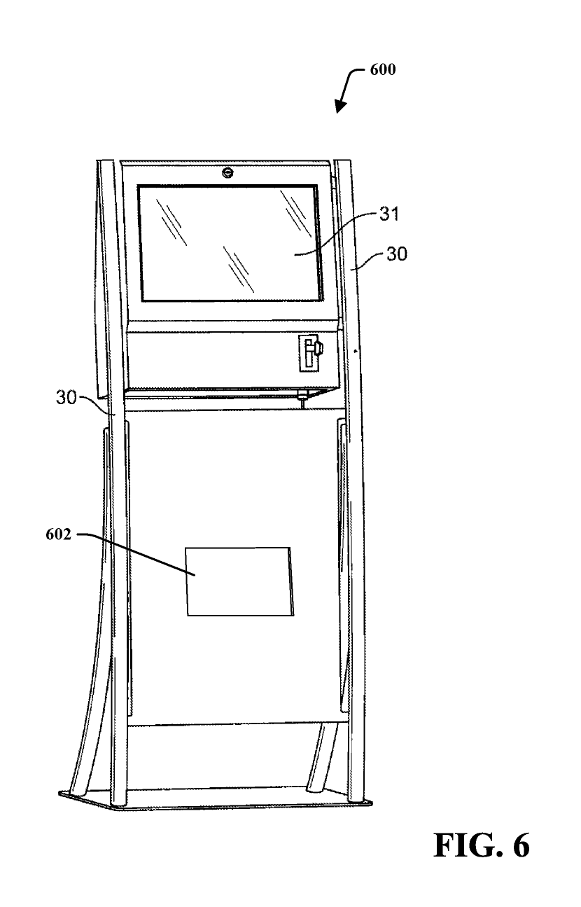

FIG. 7 illustrates an exemplary data structure of a database for a media communication system.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Moreover, terms such as “access point,” “server,” and the like, are utilized interchangeably, and refer to a network component or appliance that serves and receives control data, voice, video, sound, or other data-stream or signaling-stream. Data and signaling streams may be packetized or frame-based flows. Furthermore, the terms “user,” “customer,” “consumer,” and the like are employed interchangeably throughout the subject specification, unless context suggests otherwise or warrants a particular distinction among the terms. It is noted that such terms may refer to human entities or automated components supported through artificial intelligence (e.g., a capacity to make inference). Still further, “user,” “customer,” “consumer,” may include a commercial establishment(s), such as a restaurant, restaurant chain, commercial kitchen, grocery store, convenience store, ice-cream shop, smoothie restaurant, or the like.

Media items may refer to video, audio, video and audio, text, graphical, or other electronic messages. As such, embodiments may refer to a single form of media items for proposes of simplicity of explanation. These examples are not limited to the specific form of media item.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

A network typically includes a plurality of elements that host logic. In packet-based wide-area networks (WAN), servers (e.g., devices comprising logic) may be placed at different points on the network. Servers may communicate with other devices and/or databases. In another aspect, a server may provide access to a user account. The “user account” includes attributes for a particular user and commonly include a unique identifier (ID) associated with the user. The ID may be associated with a particular mobile device and/or blender device owned by the user. The user account may also include information such as relationships with other users, application usage, location, personal settings, and other information.

Embodiments may utilize substantially any wired or wireless network. For instance, embodiments may utilize various radio access network (RAN), e.g., Wi-Fi, global system for mobile communications, universal mobile telecommunications systems, worldwide interoperability for microwave access, enhanced general packet radio service, third generation partnership project long term evolution (3G LTE), fourth generation long term evolution (4G LTE), third generation partnership project 2, BLUETOOTH®, ultra mobile broadband, high speed packet access, xth generation long term evolution, or another IEEE 802.XX technology. Furthermore, embodiments may utilize wired communications.

It is noted that, terms “user equipment,” “device,” “user device,” “client,” and the like are utilized interchangeably in the subject application, unless context warrants particular distinction(s) among the terms. Such terms may refer to a network component(s) or appliance(s) that sends or receives data, voice, video, sound, or substantially any data-stream or signaling-stream to or from network components and/or other devices. By way of example, a user equipment device may comprise an electronic device capable of wirelessly sending and receiving data. A user equipment device may have a processor, a memory, a transceiver, an input, and an output. Examples of such devices include cellular telephones (e.g., smart phones), personal digital assistants (PDAs), portable computers, tablet computers (tablets), handheld gaming counsels, wearables (e.g., smart watches), desktop computers, stand-alone voice command devices or home automation device.

It is noted that user equipment devices can communicate with each other and with other elements via a network, for instance, a wireless network, or a wireline network. A “network” can include broadband wide-area networks such as cellular networks, local-area networks, wireless local-area networks (e.g., Wi-Fi), and personal area networks, such as near-field communication networks including BLUETOOTH®. Communication across a network may include packet-based communications, radio and frequency/amplitude modulations networks, and the like. Communication may be enabled by hardware elements called “transceivers.” Transceivers may be configured for specific networks and a user equipment device may have any number of transceivers configured for various networks. For instance, a smart phone may include a cellular transceiver, a Wi-Fi transceiver, a BLUETOOTH® transceiver, or may be hardwired. In those embodiments in which it is hardwired, any appropriate kind or type of networking cables may be utilized. For example, USB cables, dedicated wires, coaxial cables, optical fiber cables, twisted pair cables, Ethernet, HDMI and the like.

In some traditional systems, users buy rewards or collectables. For example, users may collect sports trading cards that identify players, teams, or the like. These trading cards are typically paper or cardboard material. Users can purchase these cards from a variety of retailers. These trading cards may include baseball or other sports cards. Such cards are typically released annually, and include one or more players per card.

In recent years, attendance at events has declined. These events include professional baseball games. Professional baseball has taken measure to try and reverse this trend. Such trends, however, have yet to show any significant improvements in attendance. Embodiments disclosed herein may be utilized to change this effect. More particularly, embodiments may increase attendance, publicity, or the like of events. It is noted that this disclosure is not limited to baseball events or events of any particular kind. For instance, embodiments may be utilized for sports events (armature or professional), private events, entertainment events (e.g., concerts, movies, plays, etc.), corporate events, advertising events, educational events, or the like. Moreover, embodiments may not be linked to a particular event at all. At least some embodiments may be utilized for a particular location or business (e.g., museums, attractions, amusement parks, etc.). Accordingly, it is noted that embodiments may refer to a specific event, location, or the like for simplicity of explanation.

According to embodiments, media communication systems may include on more kiosks. The kiosks may include a display, user interface, and a recording device. A user may interact with the kiosk to record a message. In another aspect, a user may interact with the kiosk to receive a reward. The reward may comprise a digital or physical reward. The media communication system may communicate with a device associated with the user (e.g., a user device) to transmit the reward to the user. The user may interact with the kiosk at one or more times to receive more than one reward. Moreover, the user may visit other or different kiosks and different locations or events to gather other rewards.

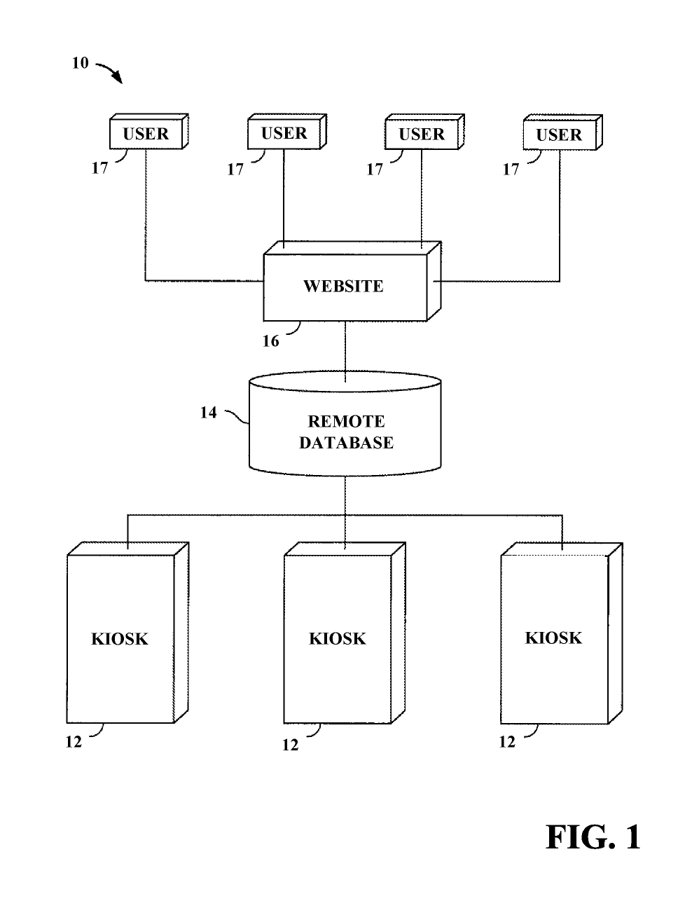

With reference to FIG. 1, the video communication system 10 may include one or more kiosks 12 in communication with a database 14. As described below in further detail, each kiosk 12 is configured to receive and store video communications and corresponding message data. The kiosk 12 is further configured to communicate with the database 14. For example, the kiosk may upload video communications to the database 14 and receive instructions or messages from the database 14. It is understood that video communications may include audio files, video files, text files, other type of electronic media files, or any combination thereof. The database 14 may receive video communications and corresponding message data from the kiosk 12 and store the video communications based on the corresponding message data.

Message data may include information related to the user creating the video communication, the place where the video communication is created, the time when the video communication is created, or any other data that identifies the video communication or user creating the video. For example, information related to the user creating the video communication may include the user's name, a user-created username, the user's address, telephone number, email address, or other personal information. Likewise, information related to the place where the video communication was created may include the address or name of the venue where the video communication was created, the name of the event taking place at the venue when the video communication was created, or other similar identifying information.

The database 14 may allow stored video communications to be remotely accessed. For example, video communications stored on the database 14 may be accessible through a website 16. In an embodiment, a user 17 may retrieve a stored video communication from the database 14 by inputting a portion of the message data related to the desired video communication into the website 16. For example, the user may input message data such as a username or password associated with the video communication. The website 16 transmits the message data to the database 14. If the desired video communication and input message data match, the user may be allowed to access the video communication. The website 16 may permit the user to stream the video communication, download the video communication, or access the video communication by any other means known in the art.

The website 16 may be a social networking website. For example, the website 16 may allow users to create a user account based on user information. Users may create a user account while logged into the website or alternatively while using the kiosk 12 by inputting user information into the kiosk 12. In an embodiment, the kiosk 12 may automatically create a user account on the website 16 based on message data input by the user. Video communications created by the user 17 at the kiosk 12 may be associated with the user's account on the website. Users on the website may connect with other users on the website to allow third party website users to access video communications.

The database 14 may send information related to the video communication and message data to a user. For example, the database 14 may send an email containing a weblink to the website 16 to the email address provided by a user. By activating the web link, a user may stream, download, or otherwise access the video communication. The database 14 may also send a text message or email web link to a cell phone, allowing the cell phone user to access the video communication. The database 14 may also send the user information related to the venue or event where the video communication was created. For example, the database may send mail or email advertisements to the user related to other events taking place at the venue where the video communication was created. Additionally, the database 14 may send advertisements to the user related to events at other venues, similar to the event where the video communication was created.

The video communication system 10 may allow persons other than the video communication creator to access the video communication via the website 16. For example, the video communication creator may input identifying information of other persons, such as email addresses, as part of the message data. Persons identified by the video communication creator will receive an email containing a web link to the website 16. By activating the web link, users 17 may access the website 16 where they may stream, download, or otherwise access the video communication. Additionally, the video communication creator may add persons to receive an email web link through the website 16. The website 16 and database 14 may limit access to the video communication based on a specified number of users 17, a predetermined length of time, or any other similar parameter.

The kiosk 12 and database 14 may be configured to communicate via a network. For example, the kiosk 12 may communicate with the database 14 via the Internet, through a satellite connection, over a telephone line, via a cloud network, or by any other remote manner of communication known in the art. In an embodiment, the kiosk 12 includes a communication connection such as an Ethernet port, Wireless Large Area Network (WLAN) connection, WIFI or wireless connection, or other known wired or wireless communication means to communicate with the database 14.

In one or more embodiments, the kiosk 12 may communicate with a user device of a user 17. The communication may take place through a network device (e.g., router), wired connection, or wireless connection. As an example, the kiosk 12 may communicate with the user device through a near field communications (NFC) protocol. The NFC communication may allow the user device to communicate with the kiosk 12 without the need for a network device or remote database. For instance, the user may interact with the kiosk 12 to record a message. The user may place their user device proximal the kiosk 12 and may be prompted to allow the kiosk 12 to communicate directly with their device. If a user allows access, the kiosk 12 may transmit the message to the user device. It is noted that the user device may comprise a mobile application (app) that may receive the message. The app may allow the user to upload to social media, store in memory, or perform other operations with the message. It is further noted that the app may receive a reward as described herein.

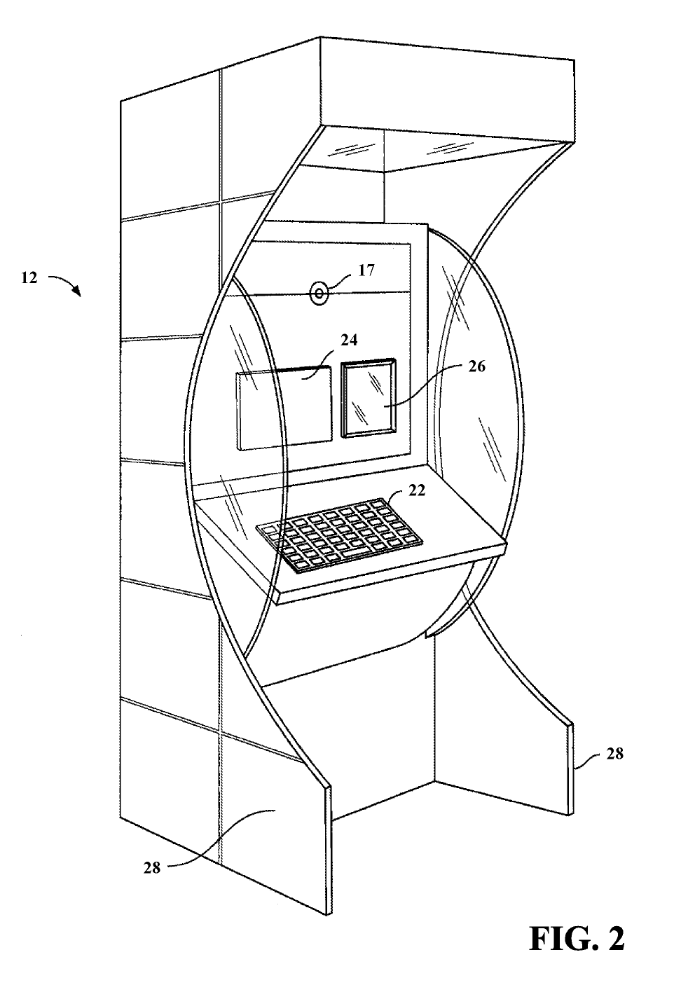

FIG. 2 illustrates an embodiment of a kiosk 12. As shown, the kiosk 12 may be a free standing unit, housing various components for recording, storing and communicating a video communication. It will be appreciated, however, that the kiosk 12 may be any unit, freestanding or supported, that houses the components described herein. The kiosk 12 includes a message-recording device 20. The message-recording device 20 may include a visual recording component, (e.g., a camera, video camera, or web camera,), an audio recording component (e.g., microphone), or the like. It is noted that the message-recording device 20 may include one or more recording components or devices. In an embodiment, a camera is connected to an adjustable apparatus (not shown). The adjustable apparatus allows the user to change the height and angle of the camera in order to record at a desired position. The adjustable apparatus may be moved by a powered device (e.g., motor, robotic, etc.) or by manual manipulation (e.g., user powered). In another aspect the adjustable apparatus may be a separate stand. The stand may include a telescoping arm, swivel, bevel, or the like.

The visual recording component may further be configured to record a portion of the venue where the kiosk 12 is located. For example, a kiosk 12 located at a baseball park may include a camera positioned to record a user such that the baseball field or other recognizable landmark is seen in the background. In one embodiment, the visual recording component may be positioned to record the user in front of a blank screen or green screen. The user may then select a background to be inserted into the video communication from a list of optional backgrounds.

In another aspect, the kiosk 12 may overlay media items or image filters over a captured image. For instance, a user may capture a video or picture include a user interface, such as an input device 22, graphical user interface 31. The user may select one or more images or filters to place over all or a portion of the captured media. In an example, the user may select to change the color, tint, brightness, sharpness, or other image quality. According to another example, the user may add a hat, glasses, or other image over the capture image. In the context of a baseball event, the hat may include a brand, logo, or advertisement. It is noted that a filter may be a static image, or an image manipulating filter. Such image manipulating filters may receive image data and may generate altered image data to create special visual effects, such as “fun-house” mirror effect or the like. In another example, the kiosk 12 may utilize voice modulation filters or techniques to alter audio. It is noted that the user may add audio effects or audio clips to the message—such as crowd noise, a sports announcers audio, or the like.

The message-recording device 20 may include a sound-recording component such as a microphone or other sound-receiving device. The sound-recording component may be integrated with or separate from a visual recording component. The message-recording device 20 may also include an input device 22, graphical user interface 31 such as a touch screen monitor, or other known components for receiving text from a user. The graphical user interface 31 may further be used as a second display to provide information to the user.

In an embodiment, the message-recording device 20 includes a digital video camera, a microphone, and a keyboard. The user may record a video communication of a specified length into the video camera. The user may further type a text or caption on the keyboard to be displayed on the video communication. The kiosk 12 may include an output device 24 to allow the user to watch or review the video communication during or after it is recorded. In another aspect, the output device 24 and/or input device 22 may comprise a user's device that communicates with the kiosk 12.

The kiosk 12 may include a memory component for storing video communications and message data. Message data captured by the message-recording device 20 may be stored on the memory component and associated with the corresponding video communication created by the user. The kiosk 12 may periodically upload the video communications and message data from the memory component to the database 14 via the remote network connection. The kiosk 12 may be configured to upload the video communications and message data based on the number of video communications stored on the memory component, set time intervals, upon capturing a media item, or any other parameter or set of parameters.

The kiosk 12 may includes an input device 22 for inputting message data. The input device 22 may include a keyboard, mouse, touch screen monitor, microphone, scanner, USB port, voice recognition, or any other means for inputting data. In one embodiment, the k input device 22 may include a device for recognizing a user based on an identifier. For example, the input device 22 may include a card reader for recognizing and reading a user card. The user card may store user data, allowing a repeat user to input message data by inserting the user card into the card reader. Additionally, the input device 22 may recognize a user based on any unique identifier, including but not limited to a user's fingerprint, retinal scan, electronic device identification, or any other biometric parameter.

In at least one embodiment, the input device 22 may comprise a scanner, such as an image scanner. The scanner may recognize an image, including a coded image (e.g., two-dimensional bar code, three-dimensional barcode, etc.). In an example, a user may be issued a Quick Response (QR) code. The QR code may be on a printed piece of paper (e.g., an event ticket, flyer, etc.), a user device (e.g., an application or app), or the like. The input device 22 may recognize the QR code and may associate the code with a user identity.

The input device 22 may include other devices, such as wireless transceivers, transmitters, or the like. For instance, the input device 22 may include a radio frequency communication device (e.g., near-field communication device, RF device, BLUETOOTH device, or other device). The input device 22 may wirelessly communicate with a user device to identify the user. In an example, the input device 22 may include a NFC device that has a limited range of communication. The user may open an app on their cell phone or other device (e.g., smart watch, wearable, etc.). The user may place the cell phone near the input device 22 and the cell phone may communicate with the input device 22. The input device 22 may receive identifying information from the cell phone to identify a user. It is noted that NFC technology may be utilized such that the input device 22 does not communicate with other users in crowded events. In another aspect, a user may opt-out or be asked to opt-in to any direct communication between the user's device and the kiosk 12.

The kiosk 12 may include an output device 24, such as a display or speaker for prompting the user to input data or communicating with the user in response to entered data. In an embodiment, the kiosk 12 includes an output device 24, and an input device 22. The output device 24 may prompt the user to enter specific user information such as name, address, telephone number, email address, or other personal information. The user may enter the information using the input device 22. In at least one example, the information may be communicated or read from a users device, a card (e.g., magnetic strip), or the like.

The information may be stored on the memory component as message data, and associated with the corresponding video communication created by the user. When a user is not interacting with the kiosk 12, the monitor may display an advertisement loop or other promotion material related to the venue or the features of the video communication system 10. Advertising and promotional material displayed by the kiosk 12 may be changed at the kiosk 12 or remotely changed by the database at any time.

The kiosk 12 includes a currency receiver 26. The currency receiver may include a bill acceptor, credit card reader, wireless communication device, or any other manner for accepting payment known in the art. The kiosk 12 may also provide alternative payment means. For example, the kiosk 12 may allow a user to pay through PayPal, EBT, billing to a cellular phone, or other alternative forms of payment. The output device 24 may prompt a user to enter payment.

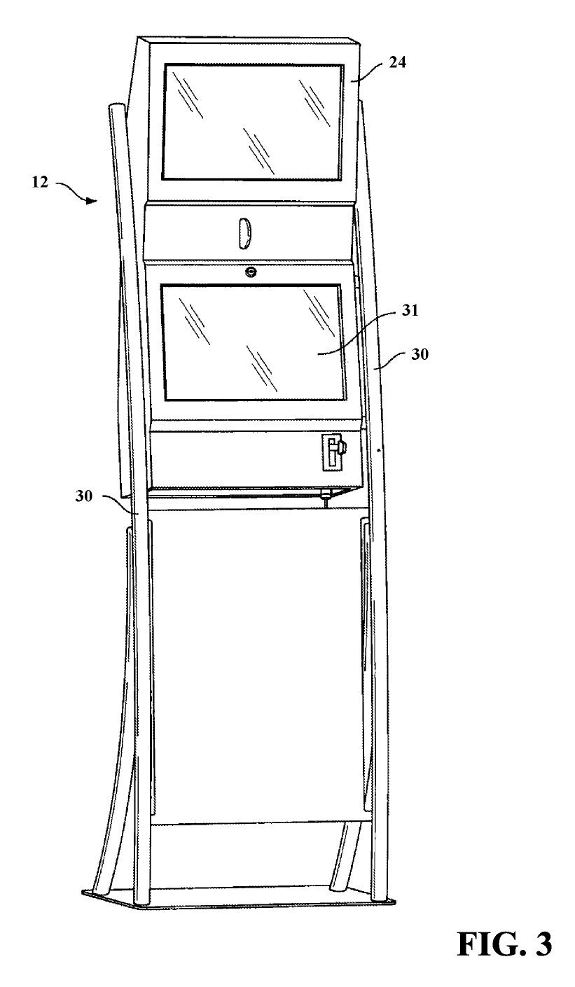

As illustrated in FIGS. 2 and 3, the kiosk 12 may be a stand-alone unit. With reference to FIG. 2, the components of the kiosk 12 may be contained within a body 28. Alternatively, as shown in FIG. 3, the components of the kiosk 12 may be connected to a leg assembly 30. It will be understood, however, that the kiosk 12 may be supported in any manner. For example, the kiosk 12 may be mounted or secured to a wall, post, or other stable portion of the venue. In addition, the kiosk 12 may be portable such as installed in a vehicle, or configured as a mobile unit. It is noted that the kiosk 12 may comprise one or more stations that may be physically separate. The stations may communicate with each other, a database, user device, or the like.

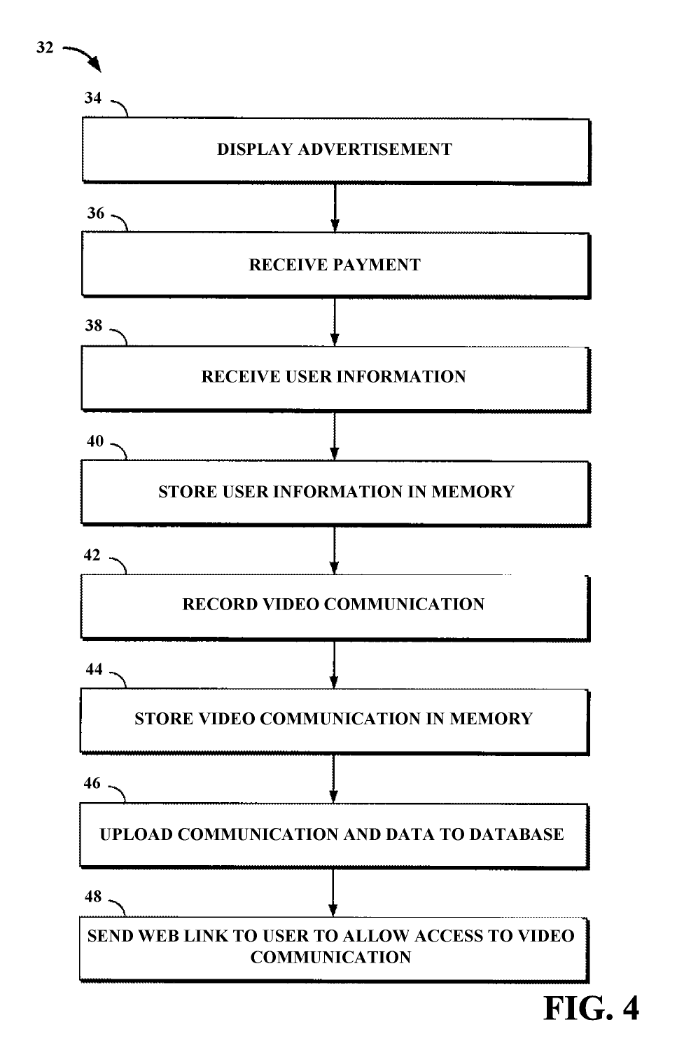

With reference to FIG. 4, the kiosk 12 may display an advertisement or promotion 34 on the output device 24 while there no user is interacting with the kiosk 12. Once a user interacts with the kiosk 12, the video communication system 10 may prompt the user to enter a specified payment 36 before recording a video communication. The kiosk 12 may verify payment by verifying credit card information via the remote network or verifying that proper bills have been inserted into the currency receiver 26. In an embodiment, the kiosk 12 may allow a user to record a video communication without paying, allowing the user to record a video communication at no charge. The kiosk 12 may prompt the user to enter user information 38. As previously described, user information may include name, address, telephone number, email address, or other personal information. The user information may be stored on the memory component 40 and associated with the video communication to be created by the user. The user may then record a video communication 42 using the message-recording device 20. In an alternative embodiment, the user may record the video communication before entering user information. It will be appreciated, however, that the steps described herein may be completed in any order and are not limited to the order illustrated in FIG. 4.

The kiosk 12 may also be oriented to include two or more stations for the user to complete the tasks of payment, video recording, and user information input (not shown). For example, the kiosk 12 may include two stations that are opposite from each other. The first station includes the features that allow a user to make a payment and record a video. The second station includes the features that allow the user to input user information. Alternatively, the two stations can be configured in any manner to allow for payment, recording, and inputting user information. It is also contemplated that the kiosk can include three or more stations to complete payment, recording, and user input on separate stations. The multiple stations may be connected to a single database 14 or may be connected to multiple databases 14.

In another aspect, a media communication system may include one or more kiosks 12 disposed at different locations. Each location may provide different vantage points, rewards, or the like. For example, kiosks 12 may be located at a plurality of baseball parks. Each kiosk 12 may provide a user a specific reward (or set of rewards) based on the baseball park at which it is located. In another aspect, a plurality of kiosks 12 may be disposed within a single baseball park. Each kiosk 12 may generate a specific reward base on the location. For instance, a kiosk 12 behind the outfield may generate digital trading cards of outfielders, while a kiosk proximal the infield may generate digital trading cards of infielders. This may encourage users to visit baseball parks and different locations in baseball parks.

The kiosk 12 stores the video communication on the memory component 44, associated with the corresponding message data. The kiosk 12 uploads the video communications and message data 46 to the database 14, via the remote network. Video communications may be uploaded to the database 14 automatically upon completion of the video communication recording. Alternatively, the video communications may be uploaded to the database 14 at a predetermined time interval, or when a predetermined amount of memory space has been used. However, it is understood that video communications and message data may be uploaded to the database 14 based on any predetermined parameter or set of parameters. The database 14 sends a communication to the user 48 to allow the user to access the video communication. For example, the database 14 may send an email to the user containing a direct link to access the video communication. Additionally, the database may grant access to the video communications by sending a web link via email that allows the video communication to be streamed to a computer, viewed on a cell phone, downloaded, or otherwise accessed.

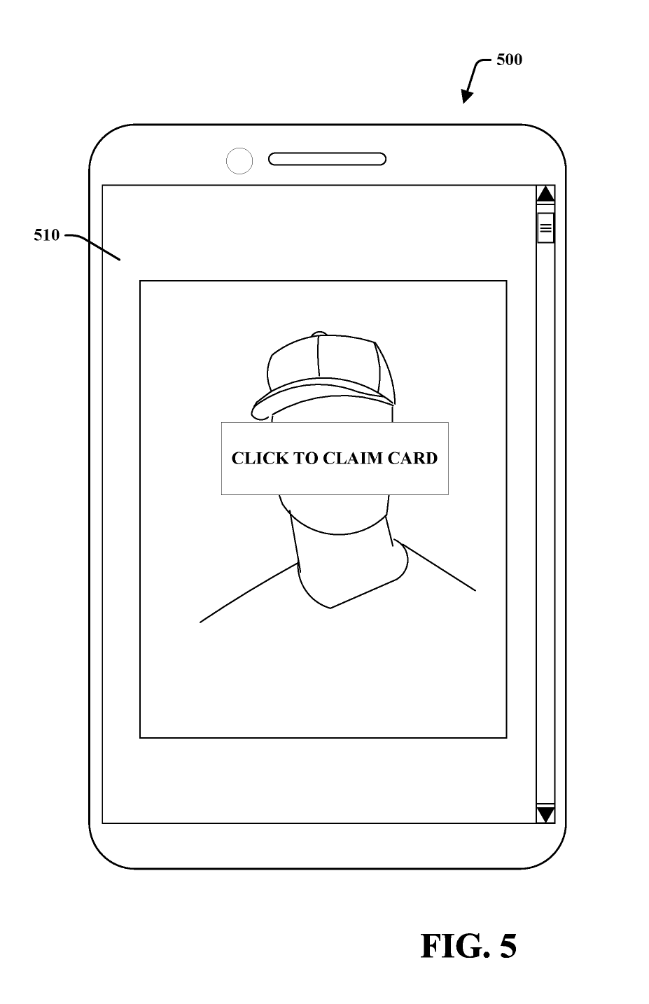

Turning to FIG. 5 with reference to FIGS. 1-4, there is an exemplary user device 500 that may communicate with a kiosk 12. The user device may include an interface 510. The interface 510 may comprise a touch screen, or other interface. It is noted that the user device 500 may communicate with various kiosks described herein.

As described herein, a kiosk 12 may be positioned at a location. The kiosk 12 may be associated with the location based on user input, GPS location devices, or the like. For instance, an administrator may manually enter a location of the kiosk 12. In another example, the kiosk 12 may include a GPS device that may determine a geographic location. The kiosk 12 may associate the location with a particular venue through a database, logic, or the like.

The kiosk 12 may generate one or more rewards to be received by a user. In an aspect, the reward may comprise a digital reward or a physical rewards. A digital reward may include an electronic reward that may be stored in computer readable memory. Examples of such rewards may include digital trading cards, digital stickers, access to media content, digital collectables (e.g., digital autographs of professional athletes), digital redeemable or discount codes, tokens (e.g., badges, credits for purchases), or the like.

It is noted that digital rewards may be protected from copying, “screen shot” capturing, sharing, duplication, or tampering through electronic media rights management techniques. The protection may prevent users from gaining access to rewards that they did not earn. It is noted, however, that the protections may be managed to allow certain actions. In an example, the remote database 14 may instruct a user device 500 and/or kiosk 12 to grant access to actions. This may allow users to trade rewards with other users.

Physical rewards may include printed products, paper or cardboard trading cards, physical stickers, physical autographs, shirts, hats, or the like. It is noted that the kiosk 12 may issue a digital reward that may be redeemed for a physical reward. The user may redeem the reward online, at another kiosk, in a store, at a register, or the like.

In another example, a kiosk 600 may include a dispensing device 602. It is noted that the kiosk 600 may comprise some or all aspects of other kiosks of this disclosure. The dispensing device 602 may comprise a printer, a vending device, or the like. For instance, the dispensing device 602 may dispense a physical reward to a user. This reward may be specific to an event, location, venue, or other parameters as described herein.

As described here and elsewhere in this disclosure, the kiosk 12 may issue rewards based on a specific location, event, day/time, venue, or the like. For instance, the kiosk 12 may comprise a memory or may access the remote database 14 for a list of possible rewards. The kiosk 12 may then identify a trigger that allows for awarding one or more rewards. The trigger may identify a day, time, place, event, or the like.

The trigger may be set by an administrator at the kiosk 12 or a remote database 14. As an example, an administrator may configure the kiosk 12 to award a reward or subset of rewards during a particular event. This event may be defined by a date and time. In one or more embodiments, the administrator may configure the kiosk 12 to generate a reward or set of rewards based on a location. The location may be set by the administrator or determine by the kiosk 12. As an example, the kiosk 12 may be placed in a baseball stadium. An administrator may configure the kiosk 12 to select one or more rewards from a database for distribution during a particular baseball game. The administrator may enter a date and time for distribution of the reward.

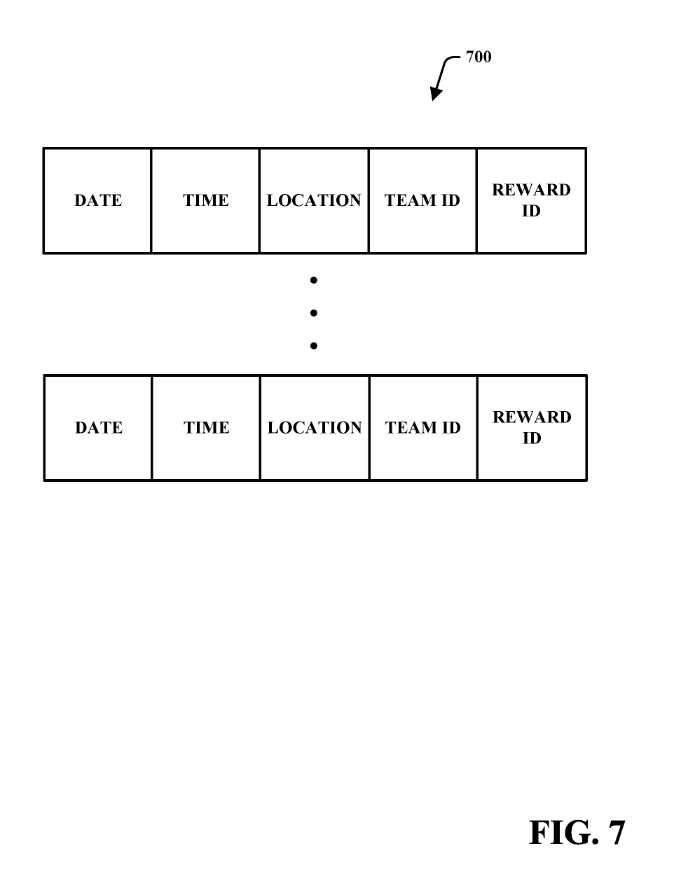

In another example, an administrator may enter a series of events into a kiosk 12 or database. Each event may be associated with triggering fields such as a date, time, location, or other information, such as teams playing for sports, artists for concerts, or the like. The kiosk 12 may monitor the fields to determine when a match occurs. The kiosk 12 may then select rewards for issuance based on the fields. In an aspect, the rewards may be manually input or may comprise a data structure 700, as shown in FIG. 7. The data structure 700 may include information that identifies triggers and the reward. When the kiosk 12 matches fields for an event with triggers for the rewards, the kiosk 12 may select the rewards for distribution. As an example, a reward may comprise an electronic trading card of a player for a professional baseball team. When the kiosk 12 identifies that the player's team is playing at the location associated with the kiosk, the kiosk 12 may select the player's trading card as a potential reward to a user. As such, particular rewards may be tied to events, locations, or the like. This may encourage users to attend events to receive event or location specific rewards.

In another aspect, the kiosk 12 may identify a triggering event based on information received from input device 22. Input device 22 may scan a bar code from a user device, ticket from an event, event program, or the like. The bar code may identify triggering information that the kiosk 12 utilizes to select a reward as a potential reward for distribution. According to at least one embodiment, the input device 22 may capture an image or audio and may generate a reward based on the captured image or audio. For instance, the input device 22 may identify a logo in an image and may select a reward based on the local. In another example, the input device 22 may identify a phrase in audio and select a reward based on the audio.

It is noted that the kiosk 12 may determine occurrence of a triggering event through computer implemented logic controls. In an aspect, the kiosk 12 may utilize artificial intelligence, statistical models, or other processes and/or algorithms to determine the occurrence of a trigger. In embodiments, the kiosk 12 may utilize classifiers that map an attribute vector to a confidence that the attribute belongs to a class. For instance, account component 130 may input attribute vector, x=(x1, x2, x3, x4, xn) mapped to f(x)=confidence(class). Such classification can employ a probabilistic and/or statistical based analysis (e.g., factoring into the analysis affinities and ingredient attributes) to infer an action that a user desires to be automatically performed. In various embodiments, account component 130 may utilize other directed and undirected model classification approaches include, e.g., naive Bayes, Bayesian networks, decision trees, neural networks, fuzzy logic models, and probabilistic classification models providing different patterns of independence. Classification may also include statistical regression that is utilized to develop models of priority. Further still, classification may also include data derived from another system, such as cameras, optical scanning devices, optical scanners, spectrometer, multi-wave length scanner, social media, or the like.

In accordance with various aspects of the subject specification, an example embodiment may employ classifiers that are explicitly trained (e.g., via a generic training data) as well as implicitly trained (e.g., via observing user behavior). For example, support vector machines may be configured via learning or training phase within a classifier constructor and feature selection module. Thus, the classifier(s) may be used to automatically learn and perform a number of functions, including but not limited to determining, according to location, time, data and other information, rewards to be issued. This learning may be on an individual basis, i.e., based solely on a single kiosk 12, or may apply across a set of kiosks. Information from the users may be aggregated and the classifier(s) may be used to automatically learn and perform a number of functions based on this aggregated information. The information may be dynamically distributed, such as through an automatic update, a notification, or any other method or means, to the entire user base, a subset thereof or to an individual user.

Kiosk 12 may award a user with a select reward via a user device, a website, social media, email or the like. As an example, a user may interact with the kiosk 12. The input device 22 may receive identification information from the user as described herein. The kiosk 12 may then issue the reward to the user, such as through NFC communication, a network, or the like. It is noted that the reward or an indication that the user received an award may automatically post to a social media network. This may increase the visibility of an event, location, or the like.

In at least one embodiment, the kiosk 12 may require the user to complete a task after the user enters information. The task may include recording a message and/or sharing the message via a social network, app, email, text, SMS messaging, or the like. The kiosk 12 may verify completion of the task and may issue the reward to the user. Requiring the user to post to social networks or otherwise disseminate a media message may raise awareness and/or increase the popularity of events and locations.

The user's rewards may be stored in the remote database 14, the user device 500, or the like. The user may access the rewards through the user device 500 or any other user device. In an aspect, the reward may include a geo-tag that identifies the time, location, event, or other parameter associated with the reward.

While examples may refer to a user device interacting with a kiosk, it is noted that the kiosk may interact with a network device. The network device may store information or rewards associated with a user account. The user may access, claim, or otherwise view their rewards via any user device. It is further noted that the user's rewards may be automatically posted to a social network and/or sent to a user's email address.

The invention has been described with reference to the embodiments. Obviously, modifications and alternations will occur to others upon a reading and understanding of this specification. The claims as follows are intended to include all modifications and alterations in so far as they come within the scope of the claim or an equivalent thereof.

What is claimed is:

1. A media kiosk system, comprising:
a portable kiosk;
an input device integrated within the portable kiosk configured to receive identification information associated with a user; and
a message-recording device integrated within the portable kiosk and configured to capture media data;
wherein the portable kiosk component is configured to:
select a digital reward to issue to the user; and
apply the digital reward to a user account associated with the user.

2. The media kiosk system of claim 1, wherein the digital reward comprises a digital trading card.

3. The media kiosk system of claim 1, wherein the digital reward comprises a digital coupon.

4. The media kiosk system of claim 1, wherein the portable kiosk component is configured select the digital reward from a set of digital rewards based at least one of a date, time, or location associate with the portable kiosk.

5. The media kiosk system of claim 4, wherein the portable kiosk determines its location.

6. The media kiosk system of claim 5, wherein the portable kiosk includes a global positioning system device.

7. The media kiosk system of claim 5, wherein the portable kiosk determines its location based on information associated with a wireless network.

8. The media kiosk system of claim 1, wherein the portable kiosk comprises an input device that operatively receives a signal from a user device.

9. The media kiosk system of claim 8, wherein the input device comprises a near field communication device.

10. The media kiosk system of claim 8, wherein the input device operatively instructs the user device to provide information associated with a user account.

11. The media kiosk system of claim 1, wherein the portable kiosk comprises an output device that operatively transmits a signal to a user device.

12. The media kiosk system of claim 11, wherein the output device operatively transmits a digital reward to the user device.

13. A media message communication system for managing messages created by a portable kiosk, the system comprising:
a database connected to a communication network, the database configured to:
receive, from the portable kiosk connected to the communication network, a request to issue a reward to a user identity;
receive, from a remote access point connected to the communication network, information associated with a request to access the reward;
determining, based on the information associated with the request, whether the request should be granted; and
in response to determining the request should be granted, allowing the remote access point to redeem to the reward.

14. The media message communication system of claim 13, wherein said database is further configured to receive reward requests from a plurality of portable kiosks including the portable kiosk.

15. The media message communication system of claim 14, wherein the database is further configured to determine a location of a requesting portable kiosk.

16. The media message communication system of claim 13, wherein the database is further configured to instruct the kiosk to issue the reward to the remote access point.

17. A portable kiosk configured to communicate with a network comprising:
an integrated message-recording device configured to record a media message; and
an input device operatively receiving identification information associated with a user;
wherein the portable kiosk generates a reward for the user based on the received identification information and at lease one of a time, date, or location of the portable kiosk.

18. The media message communication system of claim 17, wherein the portable kiosk generates the reward in response to determining whether a triggering event has occurred.

19. The media message communication system of claim 18, wherein the triggering event comprises determining that the media message has been shared with other users.

20. The media message communication system of claim 18, wherein the triggering event comprises at least one of identifying an image received by the input device, or identifying an audio pattern received by the input device.
